(19) United States
(12) Patent Application Publication
(10) Pub. No.: US 2017/0316552 A1
(43) Pub. Date: Nov. 2, 2017

(54) BLIND IMAGE DEBLURRING VIA PROGRESSIVE REMOVAL OF BLUR RESIDUAL

(71) Applicant: Ramot at Tel-Aviv University Ltd., Tel Aviv (IL)

(72) Inventors: Rana HANOCKA, Tel Aviv (IL); Nahum Kiryati, Tel Aviv (IL); Naftali ZON, Tel Aviv (IL)

(21) Appl. No.: 15/439,963

(22) Filed: Feb. 23, 2017

Related U.S. Application Data
(60) Provisional application No. 62/328,078, filed on Apr. 27, 2016.
(60) Provisional application No. 62/328,060, filed on Apr. 27, 2016.

(51) Int. Cl. G06T 5/00; G06T 5/20

(52) U.S. Cl. CPC G06T 5/003; G06T 5/20

(57) ABSTRACT

A method, a computer and a non-transitory computer readable medium for deblurring, the method may include receiving an input image; calculating, based on the input image, a first estimated blur kernel; calculating a first estimate of a latent image based on the input image and the first estimated blur kernel; and performing at least one repetitions of: receiving a current estimate of the latent image; calculating, based on the current estimate of the latent image, a next estimated blur kernel; and calculating a next estimate of the latent image based on the current estimate of the latent image and the next estimated blur kernel

### CROSS REFERENCE TO RELATED APPLICATIONS

This application claims the priority of U.S. provisional patent Ser. No. 62/328,060 filing date Apr. 27, 2016 and of U.S. provisional patent Ser. No. 62/328,078 filing date Apr. 27, 2016—both being incorporated herein by reference.

### BACKGROUND

The two major sources for image degradation are noise, usually from the imaging sensor, and blur, usually from motion or defocus. Motion blur often occurs from motion in the camera or the scene, while defocus blur results from an incorrect focus setting or a limited depth of field. Image deblurring (a.k.a. image restoration) techniques employed on a degraded image assist in recovering a sensible and meaningful resulting image. Image degradation is commonly modeled as a linear process g=u*h+n

Where the observed image (g) is comprised of the latent image (u) convolved with the blur kernel (h) plus noise (n). Image deblurring aims to recover a latent image (u) from an observed image (g).

There are two varieties: non-blind image deblurring is when the blur kernel is known, and blind image deblurring is when the blur kernel is unknown.

Even if the blur kernel is known (non-blind), this problem is severely ill-posed, since there could be infinite latent images (u) which explain an observed g and known h. In blind image deblurring the problem is even more difficult, since far more ambiguities are introduced by the unknown blur kernel (also called point spread function—PSF).

There is a growing need to provide an efficient blind deblurring method.

### SUMMARY

There may be provided a method for deblurring, the method may include receiving an input image; calculating, based on the input image, a first estimated blur kernel; calculating a first estimate of a latent image based on the input image and the first estimated blur kernel; and performing at least one repetitions of: receiving a current estimate of the latent image; calculating, based on the current estimate of the latent image, a next estimated blur kernel; and calculating a next estimate of the latent image based on the current estimate of the latent image and the next estimated blur kernel.

Any reference to an image may be applied mutatis mutandis to an image portion. For example—there may be provided a method that may include receiving an input image portion (or receiving an input image and selecting the input image portion); calculating, based on the input image portion, a first estimated blur kernel; calculating a first estimate of a latent image portion based on the input image portion and the first estimated blur kernel; and performing at least one repetitions of: receiving a current estimate of the latent image portion; calculating, based on the current estimate of the latent image portion, a next estimated blur kernel; and calculating a next estimate of the latent image portion based on the current estimate of the latent image portion and the next estimated blur kernel

There may be provided a computer that may include at least one processor and at least one memory unit; wherein the at least one memory unit is configured to receive an input image; wherein the at least one processor is configured to calculate, based on the input image, a first estimated blur kernel; and calculate a first estimate of a latent image based on the input image and the first estimated blur kernel; and wherein the at least one processor is configured to perform at least one repetitions of: receiving a current estimate of the latent image; calculating, based on the current estimate of the latent image, a next estimated blur kernel; and calculating a next estimate of the latent image based on the current estimate of the latent image and the next estimated blur kernel

There may be provided a non-transitory computer readable medium that stores instructions that once executed by a computer cause the computer to: receive an input image; calculate, based on the input image, a first estimated blur kernel; calculate a first estimate of a latent image based on the input image and the first estimated blur kernel; and perform at least one repetitions of: receiving a current estimate of the latent image; calculating, based on the current estimate of the latent image, a next estimated blur kernel; and calculating a next estimate of the latent image based on the current estimate of the latent image and the next estimated blur kernel.

The method may include determining when to stop the at least one repetitions.

The calculating of the next estimated blur kernel may be executed by a kernel estimation module and wherein the calculating of the next estimate of the latent image may be executed by a non-blind deblurring module.

The non-blind deblurring module may be a linear filter.

The linear filter may be a modified inverse filter.

The non-blind deblurring module may be a non-blind deblurring module using the MAP approach with a sparse prior.

The non-blind deblurring module may be a non-blind deblurring module using the L prior.

The non-blind deblurring module may be a non-blind deblurring module that uses a Mumford-Shah prior.

The non-blind deblurring module may be a fast image deconvolution method using hyper-Laplacian priors.

The kernel estimation module may be an alternating maximum a posteriori kernel estimation module with heavy-tailed priors.

The kernel estimation module may be a deep learning kernel estimation module.

The kernel estimation module may be a kernel estimation module that applies blur classification followed by parameter estimation.

The kernel estimation module may be a kernel estimation module that uses a normalized sparsity measure

The kernel estimation module may be a Maximum a-posteriori (MAP) kernel estimation module.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a system according to an embodiment of the invention;

FIG. 2A illustrates an image and different residual blur kernels after various iterations of the suggested method;

FIG. 2B illustrates different images and different residual blur kernels after various iterations of the suggested method;

FIG. 2C illustrates different images and different residual blur kernels after various iterations of the suggested method; and

FIG. 3 illustrates a method according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a computer capable of executing the method and should be applied mutatis mutandis to a non-transitory computer readable medium that stores instructions that once executed by a computer result in the execution of the method.

Any reference in the specification to a computer should be applied mutatis mutandis to a method that may be executed by the computer and should be applied mutatis mutandis to a non-transitory computer readable medium that stores instructions that may be executed by the computer.

Any reference in the specification to a non-transitory computer readable medium should be applied mutatis mutandis to a computer capable of executing the instructions stored in the non-transitory computer readable medium and should be applied mutatis mutandis to method that may be executed by a computer that reads the instructions stored in the non-transitory computer readable medium.

A non-limiting example of a computer is a smart phone equipped with a camera.

There is provided a framework for blind image deblurring referred to as PROBE—Progressive Removal of Blur Residual.

PROBE is a recursive progressive deblurring scheme, in which an imperfectly deblurred output of the current iteration (current estimate of the latent image) is fed back as input to the next iteration. The kernel representing the residual blur is then estimated, and used for non-blind deblurring of the current estimate of the latent image, leading to finer deblurring.

PROBE is thus different than common iterative MAP-based blind deblurring algorithms. In iterative MAP-based blind deblurring algorithms, the non-blind deblurring component is used to deblur the input image throughout the iterative process, while with PROBE the non-blind deblurring component is used to iteratively deblur the current estimate of the latent image. Furthermore, in iterative MAP-based blind deblurring algorithms, the estimated blur kernels ideally approach the true blur kernel. With PROBE, as residual blur is gradually eliminated, the estimated blur kernels ideally approach the impulse function.

PROBE does not require any parametric assumptions about the blur kernel.

PROBE is modular, demonstrated by successful results using a variety of kernel estimation and image deblurring combinations. Experimental results demonstrate rapid convergence, gain in metric performance, and excellent performance on a wide variety of blurred images.

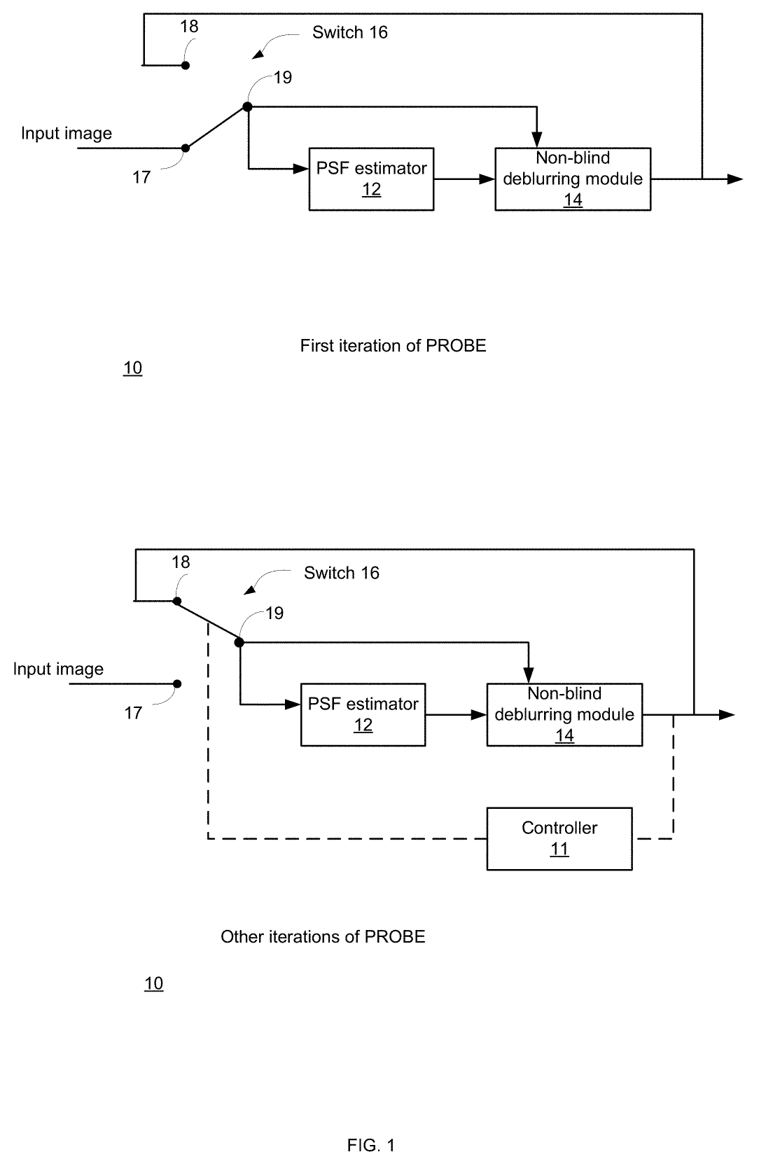

FIG. 1 illustrates system 10 that includes a kernel estimation module such as but not limited to a PSF estimator 12, a non-blind deblurring module 14 and a switch 16.

System 10 may also include a controller 11 for controlling the operation of the switch 16 and/or other modules (14, 16). The controller 11 may be fed by the output of the non-blind deblurring module 14 and/or the output of the PSF estimator 12, and may determine when a stopping condition is satisfied and the PROBE should be stopped.

Switch 16 has (a) a first input 17 for receiving an observed image (also referred to as an input image), (b) a second input 18 for receiving the output of the non-blind deblurring module 14, and (c) an output port 19 that is coupled to an input of the PSF estimator 12 and to a first input of the non-blind deblurring module 14.

The input image may be sensed by one or more image sensors (not shown) of system 10.

The output of the PSF estimator 12 is coupled to a second input of the non-blind deblurring module 14.

During a first iteration of PROBE:
a. Switch 16 feeds the input image (from input 17) to its output port 19.
b. PSF estimator 12 calculates a first estimated blur kernel.
c. PSF estimator 12 sends the first estimated blur kernel to the second input of the non-blind deblurring module 14.
d. The non-blind deblurring module 14 receives the first estimated blur kernel and the input image and calculates a first estimate of a latent image (unblurred image).

During each iteration of PROBE that follows the first iteration of PROBE:
a. Switch 16 feeds the current estimate of the latent image to its output port 19.
a. PSF estimator 12 calculates a next estimated blur kernel. The next estimated blur kernel is an estimate of the next residual blur kernel, approximating the residual blur in the current estimate of the latent image—as at least some of the blur was removed during one or more previous iterations of PROBE.
b. PSF estimator 12 sends the next estimated blur kernel to the second input of the non-blind deblurring module 14.
c. The non-blind deblurring module 14 receives the next estimated blur kernel and the current estimate of the latent image and calculates the next estimate of the latent image.
d. A stopping condition may be evaluated—to determine whether to end PROBE or to perform at least one more iteration.

A stopping condition may include a number of iterations (reaching a predefined number of iterations), and/or reaching a lower limit of improvement between consecutive iterations of the PROBE. Such improvement can be measured in the estimated latent images (for example reaching a lower limit on a measure of difference between consecutive estimates of the latent image, such as the energy of the difference image, or of estimates of the signal to noise ratio between consecutive iterations). Improvement can also be measured in the estimated blur kernels (for example, reaching a lower limit on a measure of the difference between consecutive estimates of the blur kernel, or by reaching a lower limit on the effective width of the of the estimated blur kernel). A person skilled in the art can apply many additional stopping criteria, including stopping criteria that accommodate non-monotonic convergence.

It has been observed that practically any reasonable kernel estimation module and any reasonable non-blind deblurring module may be used to implement PROBE.

Non-limiting examples of a kernel estimation module may include:
a. A deep learning kernel estimation module. (See for example the kernel-estimation aspect of: C. J. Schuler et al., “Learning to deblur”, arXiv 1406.7444, 2014).
b. An alternating maximum a posteriori kernel estimation with heavy-tailed priors, (See for example: [1] J. Kotera, F. Sroubek, P. Milanfar “Blind deconvolution using alternating maximum a posteriori estimation with heavy tailed priors”, Proc. Computer Analysis of Images and Patterns, LCNS 8048, 2013), tuned for PSF estimation as specified in section 3.3 of [1].
c. A kernel estimation module that performs blur classification followed by parameter estimation. (See for example R. Yan et al, “Image blur classification and parameter identification using two-stage deep belief networks”, Proc. BMVC, 2013.)
d. A kernel estimation module that uses a normalized sparsity measure. (See for example section 3.1 of: [2] D. Krishnan, T. Tay, and R. Fergus. “Blind deconvolution using a normalized sparsity measure”. Proc. IEEE Conf. Computer Vision and Pattern Recognition (CVPR 2011), pages 233-240).
e. Maximum a-posteriori (MAP) kernel estimation module (See A. Levin et al, “Understanding and evaluating blind deconvolution algorithms”, Proc. CVPR 2009, pp. 1964-1971.)

Non-limiting examples of a non-blind deblurring module may include:
a. A deep learning non-blind deblurring module. (See for example: J. De Vylder et al, “Image Restoration Using Deep Learning”, Proceedings of the 2016 annual machine learning conference of Belgium and The Netherlands—Benelearn 2016).)
b. A linear filter. Particular examples of suitable linear filters are a Wiener filter, a pseudo-inverse filter and a modified inverse filter. A modified inverse filter is a linear filter characterized by a transfer function of the form (equation (1)):

$${H}_{MI} = \frac{{H}^{*}}{{\vert H \vert}^{2} + C} \qquad ( 1 )$$

Where H_{MI} is the transfer function of the modified inverse filter, H is the Fourier Transform of the blur kernel, and C is a stabilizing constant. The modified inverse filter can be regarded as an approximation of the Wiener filter.
c. A non-blind deblurring module using the MAP approach with a sparse prior (See for example [1], as specified in the last line of its section 3.3.)
d. A non-blind deblurring module using the L1 prior. (See for example: C. Vogel and M. Oman, “Iterative methods for total variation denoising”, SIAM J. Sci. Stat. Comput., Vol. 17, pp. 227-238, 1996.)
e. A non-blind deblurring module that uses a Mumford-Shah prior. (See for example: L. Bar et al, “Semi-blind image restoration via Mumford-Shah regularization, IEEE Transactions on Image Processing, Vol. 15, pp. 483-493, 2006, as specified in section 5 of the paper.)
f. An image deconvolution module that uses hyper-laplacian priors. (See: D. Krishnan and R. Fergus, “Fast image deconvolution using hyper-laplacian priors”, in NIPS 2009.)

After the first PROBE iteration, the resulting estimated latent image has some residual blur, resulting from imperfections in both the kernel estimation and non-blind deblurring phase. When this residually blurred image is fed back as an input to the blur kernel estimation module, the subsequent estimated kernel is typically narrower than the first. Experiments revealed that not only was each subsequent blur kernel typically narrower than the previous one, but in certain cases converges to the impulse function.

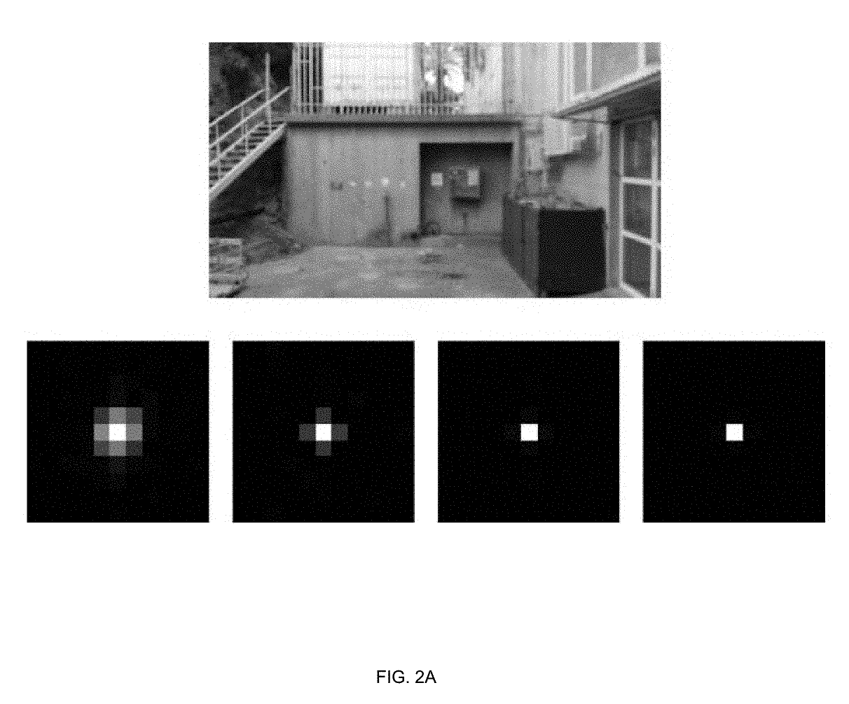

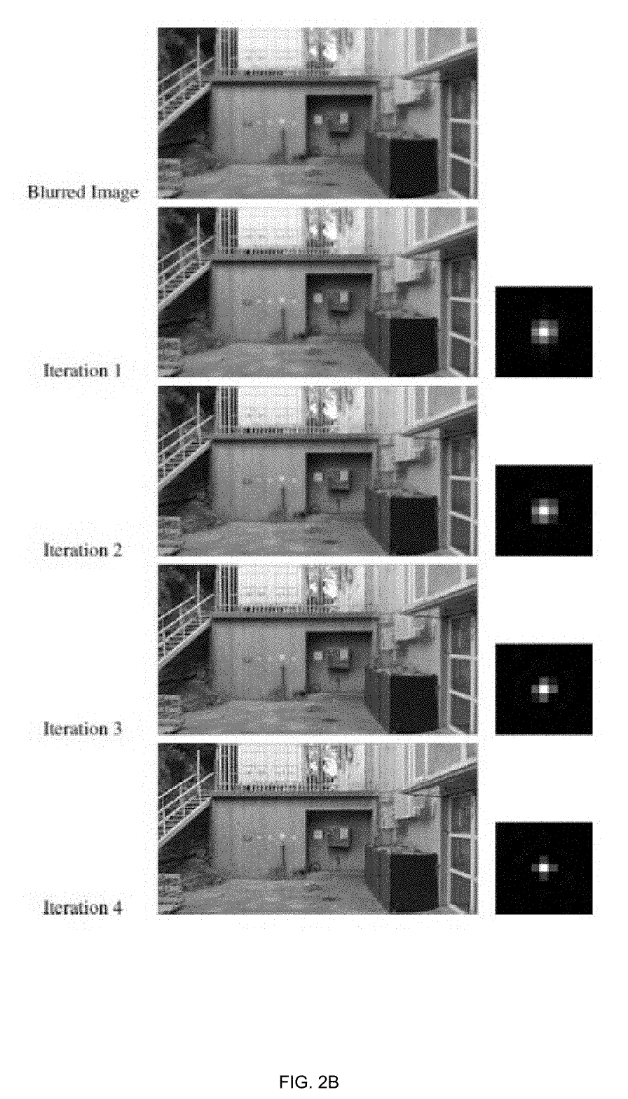

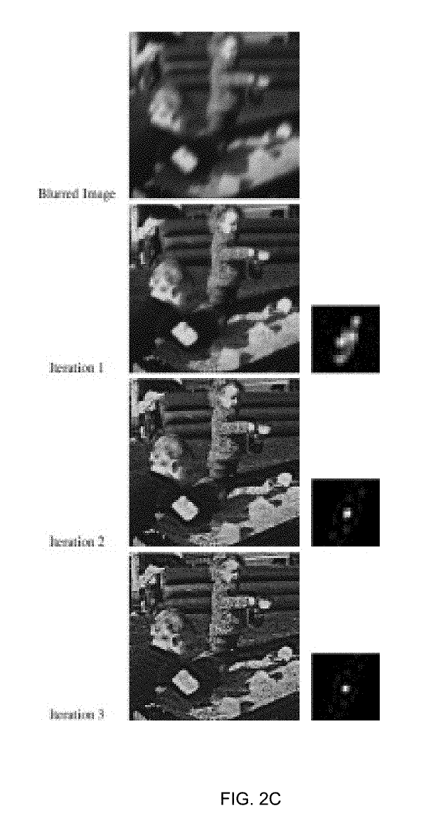

The first iteration of PROBE may remove the dominant blur, while the following iterations identify the remaining residual blurs and progressively remove them. The latent image estimate contains residual blur resulting from inexact kernel estimation and non-blind deblurring. Consider the example shown in FIG. 2A. The image displayed on top is the blurred image (out-of-focus image from a smartphone) used as an input to the progressive framework which is run for four iterations.

The blur kernel estimation module was from Kotera [1], and the non-blind deblurring phase was from Krishnan [2]. Observe that in this case, the estimated residual blur kernels converge nicely to an impulse function. A detailed analysis of this configuration is found in U.S. provisional patent Ser. No. 62/328,078 filing date Apr. 27, 2016.

FIG. 2B illustrates a defocus-blurred image, the estimated latent images, and the estimated residual blur kernels after first, second, third and fourth iteration (top to bottom respectively) using the proposed progressive framework on the above image (taken using an out-of-focus smartphone camera). The Kernel estimator was from Kotera [1]). The non-blind deblurring module was the modified inverse filter. A detailed analysis of this configuration is found in U.S. provisional patent Ser. No. 62/328,078 filing date Apr. 27, 2016. An approximate mathematical model of this configuration is analyzed in U.S. provisional patent Ser. No. 62/328,060.

FIG. 2C illustrates a motion-blurred image, the partially deblurred images after first, second and third iterations of PROBE and the estimated residual blur kernels after first, second and third iterations (top to bottom respectively). The blur kernel estimation module was from Kotera [1], and the non-blind deblurring phase was a non-blind deblurring method using the Mumford-Shah prior (Bar et al). A detailed analysis of this configuration is found in U.S. provisional patent Ser. No. 62/328,078 filing date Apr. 27, 2016.

A kernel estimation module used in the above examples is an alternating maximum a posteriori kernel estimation method with heavy-tailed priors, following Kotera et al [1], and is explained as follows:

Given a blurred image g, our goal, PSF estimation, is to estimate the blur kernel h. Let u denote the unknown sharp image. Simply, PSF estimation is the estimation of h given g.

Let R(h), called “PSF prior”, be defined as in equation (2):

$$R ( h ) = {\int }_{x , y ∈ Ω} Ψ ( h ( x , y ) ) dxdy \\ where Ψ ( h ( x , y ) ) = \{ \begin{matrix}h ( x , y ) , & if h ( x , y ) \geq 0 \\ ∞ , & otherwise\end{matrix} \qquad ( 2 )$$

Let Q(u), called “image prior”, be defined as in equation (3):

$$Q ( u ) = Φ ( {D}_{x} u , {D}_{y} u ) = {\sum }_{i} {( {[ {D}_{x} u ]}_{i}^{2} + {[ {D}_{y} u ]}_{i}^{2} )}^{\frac{p}{2}} , \\ ( 0 \leq p \leq 1 ) \qquad ( 3 )$$

Wherein Dx and Dy are partial derivative operators.

The flow is iterative, superscripts denote iteration number.
a. Initialize u⁽⁰⁾, possibly as the input image g.
b. Initialize h⁽⁰⁾, possibly as a 2-D Gaussian or as an impulse function.
c. Iterate until convergence (1 denotes iteration number)
d. Solve (i.e., optimize) equation (4) to obtain u^{(l+1)}
e. Solve (i.e., optimize) equation (5) to obtain h^{(l+1)}
f. Discard u^{(l+1)}
g. End (iterative process)
h. Use the last h^{(l+1)} as the estimated PSF.

$$\begin{matrix}{u}^{( l + 1 )} ← {min}_{u} {‖ {h}^{( l )} * u - g ‖}_{2}^{2} + Q ( u ) & ( 4 ) \\ {h}^{( l + 1 )} ← {min}_{h} {‖ h * {u}^{( l )} - g ‖}_{2}^{2} + R ( h ) s . t . h \geq 0 , {‖ h ‖}_{1} = 1. & ( 5 )\end{matrix}$$

The solution for u is eventually discarded.

In practice, equation (31-bottom) may be solved using projected alternating minimization (PAM), where h^{(l+1)} is calculated without the constraints, then the negative elements are set to zero and renormalized in order to satisfy the constraints.

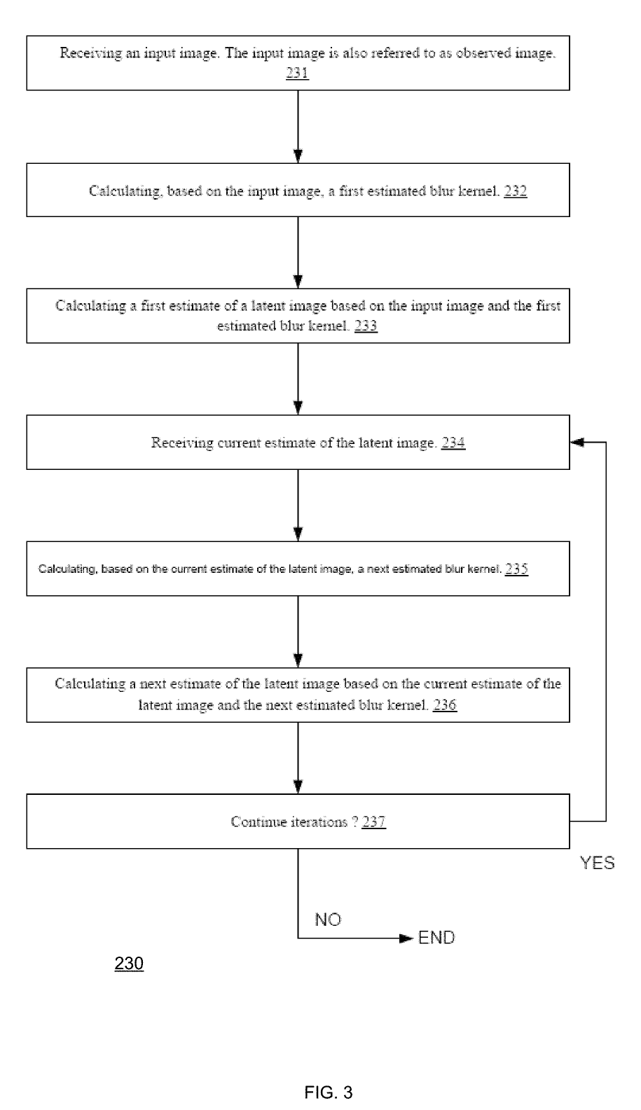

FIG. 3 illustrates a method 230 according to an embodiment of the invention.

Method 230 starts by step 231 of receiving an input image (g). The input image is also referred to as observed image.

Step 231 is followed by step 232 of calculating, based on the input image, a first estimated blur kernel (also referred to as point spread function (PSF) estimation).

Step 232 is followed by step 233 of calculating a first estimate of a latent image based on the input image and the first estimated blur kernel. Step 233 may involve applying non-blind estimation (non-blind deblurring). The first estimate of the latent image includes a residual blur and may be referred to as an imperfect deblurred image.

Step 233 is followed by one or more repetitions of steps 234, 235 and 236. The repetitions may be stopped when a predefined stopping condition is fulfilled (checked in step 237). The stopping condition may include reaching a predefined number of iterations and/or determining that the process has converged. Any stopping condition may be enforced.

Step 234 includes receiving current estimate of the latent image. During a first iteration of steps 234, 235 and 236 the current estimate of the latent image is the first estimate (calculated during step 233). During any further iteration of steps 234, 235 and 236 the current estimate of the latent image is the estimate calculated during step 236 of the last iteration.

Step 234 is followed by step 235 of calculating, based on the current estimate of the latent image, a next estimated blur kernel.

Step 235 is followed by step 236 of calculating a next estimate of the latent image based on the current estimate of the latent image and the next estimated blur kernel.

The PROBE may be implemented by any computer that includes a processor (such as a hardware processor) and a memory unit. The memory unit may store the acquired image, any estimate of the latent image and/or any estimate of the blur kernel. The computer may be a server, a camera, a desktop computer, a laptop computer, a mobile phone, a smartphone, a media player, a digital camera and the like. The computer may include an image sensor for acquiring the latent imager or may be without an image sensor.

A PROBE application was implemented on a smartphone. Accordingly—PROBE may be included in an application that is executed by an application processor or any other processor of a smartphone. The smartphone may include one or more sensors for acquiring the image that may be processed by PROBE.

PROBE has considerable potential for improving sequential blind deblurring algorithms employing blur kernel estimation followed by a deblurring phase. Designers of future deblurring algorithms should consider adopting PROBE to further improve sequential deblurring results.

The use of PROBE is not limited to the entire image. PROBE can readily be applied on a portion of an image such as an image patch or an image segment.

The image portion may be any part of the image, it may, for example form between less than one percent of the image to more than ninety nine percent of the image.

Any reference to any image should be applied mutatis mutandis to an image portion. For example, method 230 may include:
a. Receiving an input image portion.
b. Calculating, based on the input image portion, a first estimated blur kernel.
c. Calculating a first estimate of a latent image portion based on the input image portion and the first estimated blur kernel.
d. Performing at least one repetitions of:
   i. Receiving a current estimate of the latent image portion.
   ii. Calculating, based on the current estimate of the latent image portion, a next estimated blur kernel.
   iii. Calculating a next estimate of the latent image portion based on the current estimate of the latent image portion and the next estimated blur kernel.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

An image usually includes a large number of pixels and the PROBE is calculation intensive. Executing PROBE in a manual manner is either impossible or at least highly improbable.

The PROBE, especially when using a linear filter such as the modified inverse filter, requires less computations than other deblurring algorithms. This provides an improvement in computer science—as the reduced computational load allows to deblur an image with fewer computational resources and/or with a lower energy consumption.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for deblurring, comprising:
receiving an input image;
calculating, based on the input image, a first estimated blur kernel;
calculating a first estimate of a latent image based on the input image and the first estimated blur kernel; and
performing at least one repetitions of:
receiving a current estimate of the latent image;
calculating, based on the current estimate of the latent image, a next estimated blur kernel; and
calculating a next estimate of the latent image based on the current estimate of the latent image and the next estimated blur kernel.

2. The method according to claim 1 further comprising determining when to stop the at least one repetitions.

3. The method according to claim 1 wherein the calculating of the next estimated blur kernel is executed by a kernel estimation module and wherein the calculating of the next estimate of the latent image is executed by a non-blind deblurring module.

4. The method according to claim 3 wherein the non-blind deblurring module is a linear filter.

5. The method according to claim 4 wherein the linear filter is a modified inverse filter.

6. The method according to claim 3 wherein the non-blind deblurring module is a non-blind deblurring module using the MAP approach with a sparse prior.

7. The method according to claim 3 wherein the non-blind deblurring module is a non-blind deblurring module using the L1 prior.

8. The method according to claim 3 wherein the non-blind deblurring module is a non-blind deblurring module that uses a Mumford-Shah prior.

9. The method according to claim 3 wherein the non-blind deblurring module is a fast image deconvolution method using hyper-Laplacian priors.

10. The method according to claim 3 wherein the kernel estimation module is an alternating maximum a posteriori kernel estimation module with heavy-tailed priors.

11. The method according to claim 3 wherein the kernel estimation module is a deep learning kernel estimation module.

12. The method according to claim 3 wherein the kernel estimation module is a kernel estimation module that applies blur classification followed by parameter estimation.

13. The method according to claim 3 wherein the kernel estimation module is a kernel estimation module that uses a normalized sparsity measure

14. The method according to claim 3 wherein the kernel estimation module is a Maximum a-posteriori (MAP) kernel estimation module.

15. A non-transitory computer readable medium that stores instructions that once executed by
a computer cause the computer to:
receive an input image;
calculate, based on the input image, a first estimated blur kernel;
calculate a first estimate of a latent image based on the input image and the first estimated blur kernel; and
perform at least one repetitions of:
receiving a current estimate of the latent image;
calculating, based on the current estimate of the latent image, a next estimated blur kernel; and
calculating a next estimate of the latent image based on the current estimate of the latent image and the next estimated blur kernel.

16. The non-transitory computer readable medium according to claim 15 that stores instructions for determining when to stop the at least one repetitions.

17. A computer that comprises at least one processor and at least one memory unit; wherein the at least one memory unit is configured to receive an input image; wherein the at least one processor is configured to calculate, based on the input image, a first estimated blur kernel; and calculate a first estimate of a latent image based on the input image and the first estimated blur kernel; and wherein the at least one processor is configured to perform at least one repetitions of: receiving a current estimate of the latent image; calculating, based on the current estimate of the latent image, a next estimated blur kernel; and calculating a next estimate of the latent image based on the current estimate of the latent image and the next estimated blur kernel.

18. The computer according to claim 17 wherein the at least one processor is configured to determine when to stop the at least one repetitions.

19. A method for deblurring, comprising:
receiving an input image portion;
calculating, based on the input image portion, a first estimated blur kernel;
calculating a first estimate of a latent image portion based on the input image portion and the first estimated blur kernel; and
performing at least one repetitions of:
receiving a current estimate of the latent image portion;
calculating, based on the current estimate of the latent image portion, a next estimated blur kernel; and
calculating a next estimate of the latent image portion based on the current estimate of the latent image portion and the next estimated blur kernel.
